(19) United States
(12) Patent Application Publication
(10) Pub. No.: US 2011/0113335 A1
(43) Pub. Date: May 12, 2011

(54) Systems and Methods for Replacing Audio Segments in an Audio Track for a Video Asset

(75) Inventors: Alan S. Rouse, Lawrenceville, GA (US); Charles H. Dasher, Lawrenceville, GA (US); Hugh Watkins, Canton, GA (US)

(73) Assignee: Tandberg Television, Inc.

(21) Appl. No.: 12/613,620

(22) Filed: Nov. 6, 2009

(51) Int. Cl. G06F 3/00

(52) U.S. Cl. 715/723

(57) ABSTRACT

Various embodiments of the present invention generally relate to systems and methods for replacing audio segments in an audio track for a video asset. In particular embodiments, the systems and methods replace audio segments in an audio track for the video asset by defining the audio segments via audio track avails and using the audio track avails to locate and replace the audio track segments in the video asset with various audio assets.

### BACKGROUND OF THE INVENTION

1. Field of the Invention

The disclosed invention generally relates to systems and methods for replacing audio segments in an audio track for a video asset, and more specifically, to systems and methods for replacing audio segments in an audio track for a video asset by defining the audio segments via audio track avails and using the audio track avails to locate and replace the audio track segments in the video asset with various audio assets.

2. Description of the Related Art

A video asset (e.g., multimedia that includes video and audio) is commonly released with an audio track that provides the audio for the asset. For example, the audio track for a particular video asset, such as a motion picture, television program, or video game, may include dialogue, sound effects, and/or background music. In many cases, a distributor and/or a provider of the video asset may wish to replace one or more parts of the audio track. For instance, the provider may broadcast a James Bond motion picture that was released in the nineteen-seventies and may wish to replace the opening song in the picture with a more up-to-date song by a new artist. Further, the provider may wish to replace and/or add other sounds in the audio track such as a new sound effect, new music to replace existing music, and/or add a commercial playing over a radio in a particular scene of the picture.

In particular situations, this may create advertising opportunities for distributors and/or providers of the video asset. For example, a character may receive a call on his or her cell phone in a particular scene of a motion picture. The distributor and/or provider of the motion picture may wish to sell the ring tone sound to be heard in the scene to highest bidder. For instance, the distributor and/or provider may approach several wireless carriers and may propose inserting a particular ring tone that is known to be used for each of the wireless carriers. Thus, the distributor and/or provider may sell the ring tone to a particular wireless carrier and may insert the wireless carrier's ring tone into the scene. As a result, the motion picture is distributed with the particular carrier's ring tone and the carrier's ring tone is heard when the motion picture is shown. In many cases, the distributor and/or the provider may wish to insert the ring tone after the picture has been released so that they can sell the ring tone “advertisement” more than once. Therefore, a need exists to identify segments in an audio track for a video asset that may be identified and replaced with different audio assets (e.g., replacements segments).

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a schematic diagram illustrating the replacement of a particular segment in an audio track with a replacement segment according to various embodiments of the invention.

FIG. 2 is a schematic diagram illustrating a service provider system according to various embodiments of the invention.

FIG. 3 is a schematic diagram illustrating a replacement server according to various embodiments of the invention.

FIG. 4 is a flow diagram of an audio track avail creation module according to various embodiments of the invention.

FIG. 5 is a schematic diagram of a layout for an audio track avail file according to various embodiments of the invention.

FIG. 6 is a flow diagram of a replacement module according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### Brief Description of Replacing an Audio Segment

Various embodiments of the present invention provide systems and methods for identifying and replacing an audio segment in an audio track for a video asset with a replacement segment (e.g., audio asset). For purposes of this disclosure, “video asset” is a particular multimedia comprising video and audio components. For instance, a video asset may be a motion picture, a television program, and/or a video game. The term “audio track” is the audio component of a video asset that comprises the audio played in the video asset. For instance, the audio track of a motion picture may include the music, dialogue, and sound effects heard in the motion picture. An “audio segment” is a portion of the audio track. This portion may be a section of the audio track or may be the entire audio track. For instance, the audio segment may be the opening music played in a motion picture.

Furthermore, the term “distributor” is used from this point forward to indicate an entity that produces and/or distributes video asset. The term “service provider” is used to indicate a cable service provider, a satellite TV provider, or any other provider of distributed video assets.

Typically, an audio track for a video asset is produced by mixing (e.g., combining) several audio tracks into one or more channels. For example, the background music may be recorded on twenty-four tracks, the dialogue for the movie may be recorded on four or five tracks, and the sound effects may be recorded on different four or five tracks. Depending on the type of audio track produced for the video asset, these tracks are then mixed and distributed among one or more channels. For instance, if the audio track is provided in stereo, the audio tracks are mixed to two different channels (e.g., a right channel and a left channel). Therefore, when the video asset is played, the various elements of the audio are directed to the right speaker or the left speaker depending on which channel the element is provided on. If the audio track is provided in surround sound, the audio tracks may be mixed to five, six, or seven different channels, for example. Thus, when the video asset is played, the various elements of the audio are directed to different speakers that “surround” the audience based on which channel the elements are provided on.

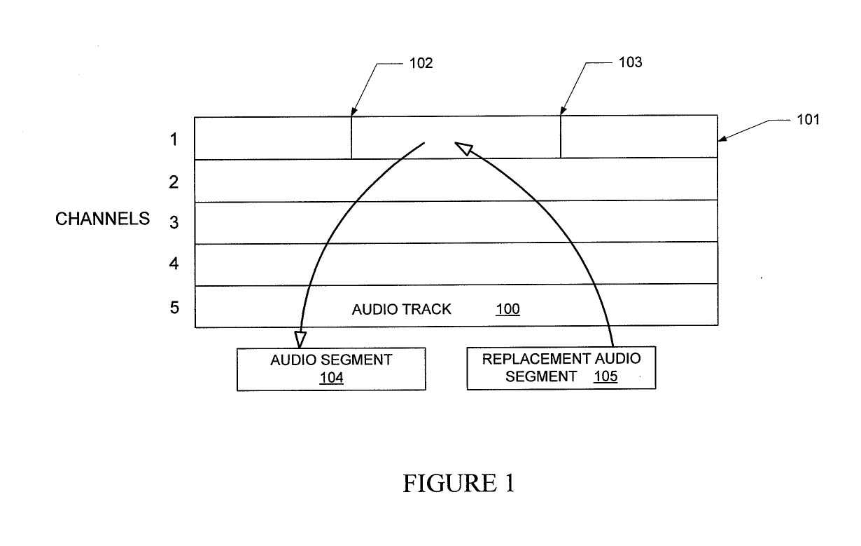

FIG. 1 illustrates the replacement of a particular segment of one or more channels 101 in an audio track with a replacement segment according to an embodiment of the invention. As is described in more detail below, a segment of one or more particular channels 101 is identified in the audio track 100 by markers (the segment is only on one channel in the example shown in FIG. 1). For instance, in one embodiment, markers may be placed in the audio track section of the video asset file that identify and a starting point 102 of the segment to be replaced in the channel 101 and a stopping point 103 of the segment to be replaced in the channel 101. In another embodiment, the starting and stopping points 102, 103 for the segment may be saved as metadata within the video asset file or may be saved in a separate file (e.g., audio track avail file).

Further, one or more replacement segments 105 may be created for the particular audio segment that may be used to replace the audio segment in the video asset file. In various embodiments, these may be referred to as “audio assets.” For instance, in one embodiment, the video asset distributor may provide the tracks that were used to produce the audio track in the asset. Someone may then use the tracks to replace various audio elements within the tracks and may remix the tracks to produce a replacement segment 105 for the identified audio segment 104 in the audio track 100 of the video asset file. In other instances, the person may create a replacement segment 105 from scratch and reproduce the sounds on new tracks and mix the tracks to produce the replacement segment 105. Those of ordinary skill in the art can envision various methods that may be used to create replacement segments 105 in light of this disclosure. Once the particular segment 104 has been identified and one or more replacement segments 105 have been created, various systems and methods of the invention are configured to remove the segment 104 of the audio track and replace the segment 104 with a replacement segment 105 of audio.

For example, an individual (e.g., distributor and/or service provider) may wish to replace the background music in a particular scene of a motion picture. The individual identifies the particular one or more channels the background music is played on (e.g., the single channel 101 shown in FIG. 1) and marks the starting point 102 and the ending point 103 for the audio segment to replace. For instance, in one embodiment, the individual records the channel 101 for the background music and the points 102, 103 in one or more metadata files (e.g., one or more audio track avail files). In addition, the individual may also record other parameters in the metadata files, such a unique identifier that identifies the particular audio track segment to be replaced, a human-readable description of the audio track segment (such as, for example, text that describes the audio track segment as background music or car explosion), an indicator for the type of audio to be replaced (such as, for example, 1 for background music, 2 for dialogue, or 3 for sound effect), and an identifier for a particular audio asset 105.

Further, the individual may create the audio asset 105 (or may be provided with the audio asset 105) that is used to replace the particular audio segment 104 identified by the individual. For example, the individual may create an audio asset 105 from a new song or may use the tracks for the original song currently played in the background of the scene and remix the tracks to change the sound of the song to create the audio asset 105.

Accordingly, when the motion picture is distributed and viewed, various embodiments of the invention read the one or more audio track avail files, read the starting and stopping points 102, 103 and the channel 101 from the audio track avail files to identify the audio segment 104 to be replace, retrieve the audio asset 105 identified in the audio track avail files, replace the audio segment 104 with the audio asset 105 in the channel 101 of the audio track 100, and distribute the video asset to one or more viewers. For example, a content provider may be streaming the motion picture over its distribution network to one or more subscribers for viewing. Thus, in this example, components of the content provider's system replace the audio segment 104 with the audio asset 105 in the audio track 100 and stream the motion picture with the audio asset 105 over its distribution network. As a result, subscribers who are viewing the motion picture hear the new song that has replaced the original background song when viewing the particular scene of the picture.

### Systems Architecture

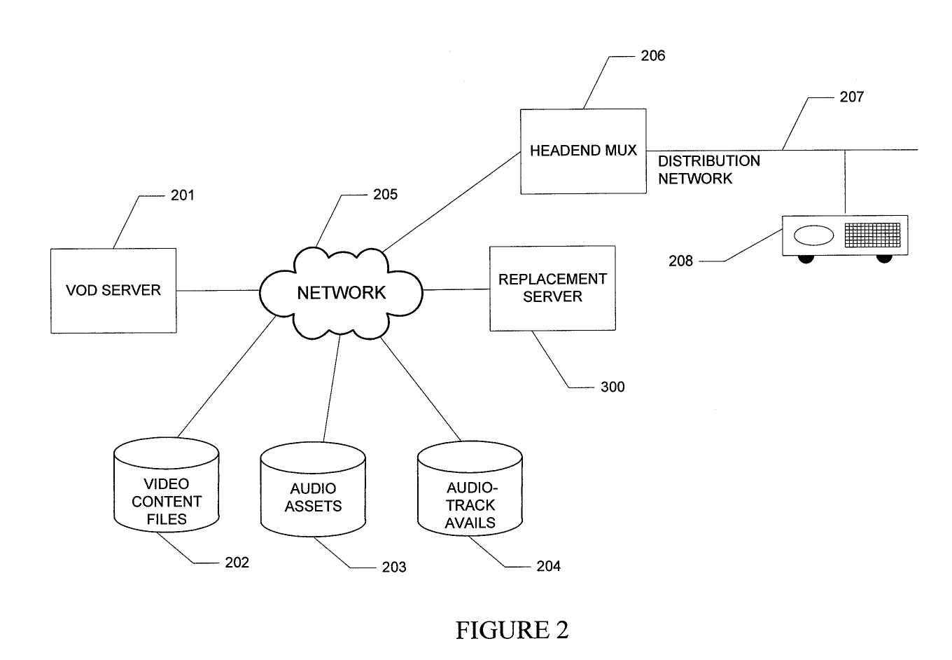

A configuration of a system 200 according to various embodiments of the invention is shown in FIG. 2. The configuration of the system 200 shown in FIG. 2 may be the system of a service provider, such as a cable provider's system providing cable programming to the cable provider's subscribers. However, the configuration 200 may also be a satellite TV provider's system or other providers of video asset's system.

In various embodiments, the system 200 includes a VOD server 201 and a replacement server 300. The VOD server 201 may be configured to provide video on demand (VOD) services to various subscribers of the service provider. For instance, the VOD server 201 in various embodiments processes request received from subscribers to stream particular video assets to the subscribers, retrieves the video assets, and facilitates having the assets streamed to the subscribers. As described in greater detail below, the replacement server 300 is configured in various embodiments to replace audio segments in the audio track of a particular video asset with different audio tracks (e.g., audio assets).

In addition, in various embodiments, the servers 201, 300 are connected over one or more communication channels 205, such as a local area network (LAN), a wide area network (WAN), a wireless network, or the Internet. Further, the servers 201, 300 are in communication over the one or more network 205 with a headend 206. In particular embodiments, the headend 206 is also in communication with a distribution network 207 and streams content over the distribution network 205 to one or more set-top boxes 208. In general, a set-top box 208 is a device that is used by a subscriber of the service provider to receive digital cable signals for television and is configured to send data to the headend 206. For example, the set-top box 206 may be a personal video recorder (PVR) or a cable box provided by a cable company. The PVR or cable box receives the digital cable signal (e.g., data packets) and feeds the signal into an individual's television set so that the individual can view the cable company's cable television programming.

In addition, in various embodiments, the system 200 may also include storage media, such as video asset files storage 202, audio assets storage 203, and audio track avails storage 204. This storage 202, 203, 204 may also be connected via the one or more networks 205 and may communicate with other components of the system 200. As described in further detail below, in various embodiments, the video asset storage 202 may store video assets (e.g., video asset files) that are streamed over the service provider's distribution network 207 to a given subscriber's set-top box 208. The audio assets storage 203 may store audio assets that are used to replace segments of an audio track in video assets. The audio track avails storage 204 may store audio track avails files that identify various segments of audio tracks in video assets that may be replaced and the corresponding audio assets. In various embodiments, the storage 202, 203, 204 may be one or more types of storage media such as hard disks, magnetic tapes, or flash memory.

Further, it should be understood that components of the systems 200 may be combined with other components in the systems 200 in various embodiments. For example, the video asset files storage 202 may reside on the VOD server 201 instead of being a separate storage medium. Therefore, the system 200 depicted in FIG. 2 is provided for illustrative purposes only and should not be construed to limit the scope of the claimed invention.

### Exemplary Replacement Server

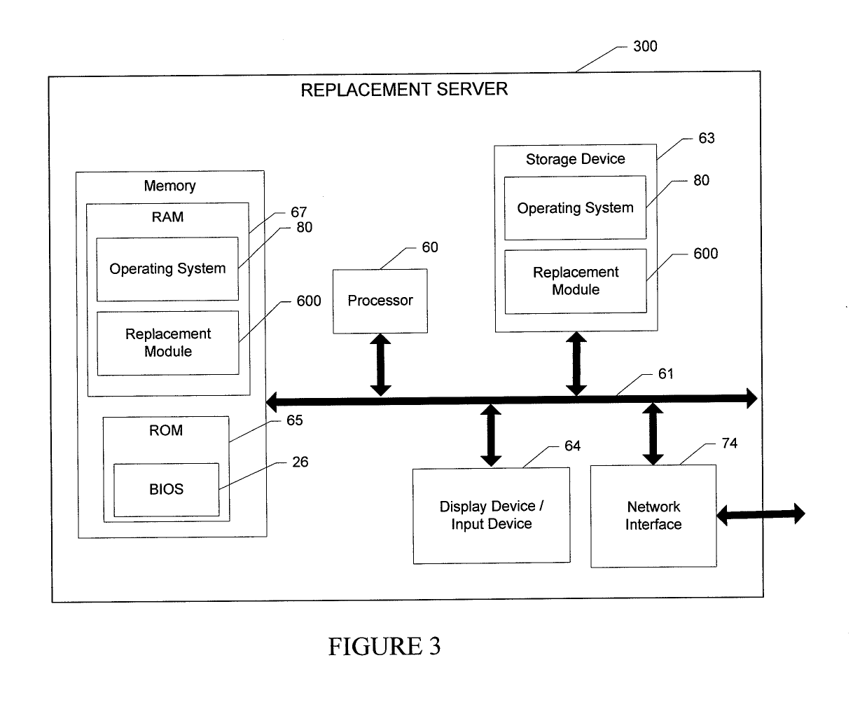

FIG. 3 provides a schematic diagram of a replacement server 300 according to one embodiment of the invention. The replacement server 300 includes a processor 60 that communicates with other elements within the server 300 via a system interface or bus 61. Also connected to the server 300 is a display device/input device 64 for receiving and displaying data. This display device/input device 64 may be, for example, a keyboard or pointing device that is used in combination with a monitor. The server 300 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 300. Alternatively, the server 300 can operate on one computer or on multiple computers that are networked together.

In addition, the server 300 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for the server 300. It is important to note that the computer-readable media described above could be replaced by any other type of computer-readable media known in the art. Such media include, for example, magnetic cassettes, flash memory cards, digital video disks, and Bernoulli cartridges.

A number of program modules (e.g., set of computer program instructions) may be stored by the various storage devices and within RAM 67. For example, as shown in FIG. 3, program modules of the server 300 may include an operating system 80 and a replacement module 600. This module 600 may be used to control certain aspects of the operation of the server 300, as is described in more detail below, with the assistance of the processor 60 and an operating system 80.

Also located within the server 300 is a network interface 74, for interfacing and communicating with other elements of one or more networks (such as the network 205 described in the configuration of the system 200 depicted in FIG. 2.) It will be appreciated by one of ordinary skill in the art that one or more of the server's 300 components may be located geographically remotely from other server 300 components. Furthermore, one or more of the components may be combined, and additional components performing functions described herein may be included in the server 300.

### Exemplary System Operation

As mentioned above, the system 200 according to various embodiments is configured to identify audio segments that may be replaced in an audio track for a video asset and to replace the audio segments with audio assets. In particular embodiments, an audio track avail creation module 400 may be used to create audio track avails and corresponding files for the avails. Accordingly, this module 400 may be a stand-alone computer program that resides on a user's personal computer or may reside in a network and may be configured to be accessed and used by several users. Further, in particular embodiments, the service provider's system 200 may include a replacement module 600 that is configured to identify audio segments that can be replaced in an audio track and to replace the audio segments with audio assets. These modules 400, 600 are described in more detail below.

### Audio Track Avail Creation Module

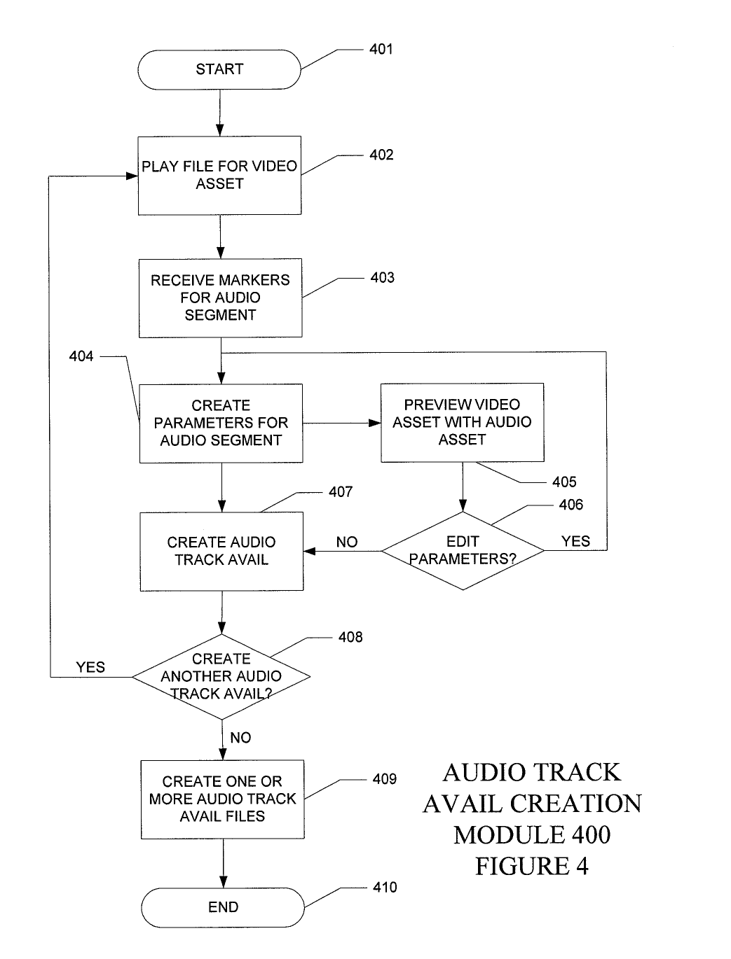

FIG. 4 illustrates a flow diagram of an audio track avail creation module 400 according to various embodiments. This flow diagram may correspond to the steps carried out by a processor in a personal computer (PC) and/or in a server that resides in a network as it executes the module 400 in the PC's/server's RAM memory according to various embodiments.

In various embodiments, the audio track avail creation module 400 incorporates a GUI that allows a user to review a video asset (such as a motion picture file) and identify one or more segments of the audio track for the video asset that may be replaced with new segments (e.g., audio assets). Further, the audio track avail creation module 400 is configured to facilitate defining parameters for each of the identified audio segments and to create an audio track avail for each of these segments.

Turning to FIG. 4, in various embodiments, the user reviews the video asset (e.g., motion picture file) by using the audio track avail creation module 400. In particular embodiments, the users opens the video asset file and selects a “play” button to watch the video asset and the module 400 plays the asset on a display in communication with the device on which the module 400 resides, shown as Step 402. During the review of the video, the user identifies a segment of the audio track the user would like to define as a segment of the audio track to be replaced. For example, the user reviews the opening credits of the James Bond movie “Live and Let Die” and identifies that he or she would like to define the opening song by Paul McCartney as a segment of the audio track to replace. In another example, the user reviews a scene in the movie in which James Bond receives a phone call on a mobile device and decides that he or she would like to define the ring tone for the mobile device as a segment of the audio track to replace. The user stops the review of the video and positions the video to a point in which the song and/or the ring tone is first heard (e.g., rewinds the video to the first frame in which the audio is heard). At this point, the user marks this point as the starting point for the audio segment. For instance, in one embodiment, the audio track avail creation module 400 records the time code for the particular point in the video file for the starting point. Accordingly, in one embodiment, the user then marks a point as the ending point for the audio segment in similar fashion, or in another embodiment, the user indicates an amount of time from the staring point to identify the ending point of the audio segment. Thus, in Step 403, the audio track avail creation module 400 receives a starting pointer and an ending indicator for the identified audio segment (e.g., markers).

In various embodiments, the audio track avail creation module 400 places these markers in the video asset file. For example, in one embodiment, the module 400 places the staring pointer and the ending indicator as metadata at the beginning of the video asset file. In another example, the module 400 places the pointer and indicator within the audio track. Still, in other embodiments, as is described below, the module 400 places the pointer and indicator in a separate file associated with the particular audio segment.

Further, in Step 404, the user enters audio segment description information for the identified audio segment and the audio track avail creation module 400 creates one or more parameters from the information. For example, in various embodiments, once the user has identified the starting point and the ending point for the audio segment, the user reviews the various channels of the audio track to identify which channels the audio segment is played over in the video asset. Thus, in these particular embodiments, the audio track avail creation module 400 is configured to allow the user to analyze the various channels of the audio track and to review what audio are played on each channel. In particular instances, the audio segment may be played on every channel. For example, in the case in which the user would like to replace the opening song to the movie “Live and Let Die,” the song may be spread across all of the channels. However, in other instances, the audio segment may only be played on a few of the available channels. For example, in the case of the mobile device ring tone, the ring tone may only be played on one or two of the channels. Therefore, the user identifies what channels are associated for the particular audio segment.

In addition, the user may identify other audio segment description information according to various embodiments. For instance, the user may provide a description of the audio segment, such as background music, dialogue, and/or sound effect. The user may also identify the genre of music in the instances which the audio segment is associated with music. Further, the user may identify one or more audio assets that may be used to replace the audio segment.

These audio assets may be provided to the user and/or may be created by the user. For instance, in various embodiments, the user may create one or more audio assets that may be used to replace the audio segment in tandem with creating the audio track avail for the particular audio segment. In particular embodiments, the user may be provided with the various tracks that were used (e.g., combined) originally to create the audio track for the particular video asset. Thus, in these particular instances, the user uses these tracks to “alter” the audio on the tracks and/or create new tracks that the user combines to create an audio asset that may be used to replace the audio segment. For example, the user may use the tracks for the scene in with the mobile device ring tone and may alter the ring tone in the track that contains the ring tone (e.g., replace the ring tone in the track with a new ring tone or re-record the track with a different ring tone). The user may then combine the tracks to create an audio asset with a different ring tone that may be used to replace the audio segment in the movie.

In other instances, the user may simply create the audio assets from scratch. For example, in the case wherein the user wants to replace the opening song in the James Bond movie “Live and Let Die,” the user may create an audio asset from Guns N' Roses'® version of the “Live and Let Die” theme song to replace the opening song in the movie.

Once the audio track avail creation module 400 has generated all of the parameters for the audio segment, in Step 405, the user may review the video asset with the one or more identified audio assets. Thus, in various embodiments, the audio track avail creation module 400 is configured to import an audio asset and play the video asset with the audio asset inserted for the audio segment. In Step 406, the audio track avail creation module 400 receives input from the user as to whether he or she would like to edit the parameters based on the review of the video asset with the audio segment replaced with the audio asset. If the user wants to edit the parameters, the user selects an option on the review screen to edit the parameters and the audio track avail creation module 400 returns to the screen(s) that facilitates the user defining the parameters, at Step 404. If the user does not want to edit the parameters, the user selects an option to create an audio track avail for the audio segment and the audio track avail creation module 400 creates an audio track avail for the audio segment by saving the parameters for the particular audio segment, shown as Step 407. In various embodiments, the audio track avail creation module 400 may save the parameters to one or more files or may temporarily save the parameters in memory. At this point, the user has created an audio track avail for the particular audio segment in the video asset. Further, in particular embodiments, the audio track avail creation module 400 also assigns a unique identifier to the audio track avail. This unique identifier may be used to identify (e.g., reference) the particular audio track avail.

In Step 408, the user indicates whether he or she would like to create another audio track avail for the video asset. For instance, in one embodiment, the user selects a control (e.g., a button on the screen) that indicates to the audio track avail creation module 400 that the user would like to continue to review the video asset. Thus, the audio track avail creation module 400 receives the input and returns to the screen(s) associated with Step 402 so that the user may continue to review the video asset and identify another audio segment.

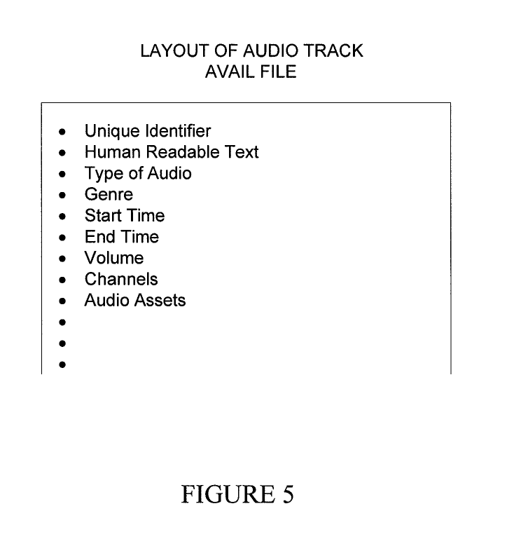

Once the user has completed creating audio track avails for the video asset, the audio track avail creation module 400 creates one or more audio track avail files for the video asset, at Step 409. In particular embodiments, these files include the entire audio track avails created for the video asset. For instance, in one embodiment, the files include one file that provides a listing of the audio track avails that have been created for the particular video asset (e.g., the unique identifiers for the audio track avails). This listing lists the audio track avails sequentially as they are found in the video asset and provides information on where the audio segments are located within the audio track and/or descriptions of the audio segments. For example, the information may include the markers (e.g., staring pointer and ending indicator) for each audio segment. As is described in more detail below, this information is used in various embodiments to locate the audio segment in the video asset and replace the segment with an audio asset. Further, in various embodiments, the audio track avail files may also include additional files that store the parameters for the audio track avails. For instance, FIG. 5 provides a layout 500 of a file that contains the parameters for a particular audio segment according to various embodiments. This layout includes a unique identifier (e.g., alphanumeric) that identifies the audio track avail and/or the audio segment, human readable text that comprises text that may be read by an individual that provides a description of the audio segment, a descriptor for the type of audio the audio segment corresponds to, the genre of music the audio segment falls into in instance in which the audio segment is associated with music, a start time (e.g., pointer) that represents the time in the audio track in which the audio segment begins, an end time (e.g., indicator) that represents the time in the audio track in which the audio segment ends or an amount of time from the start time the audio segments ends, a volume for the audio segment, the channels on which the audio segment is found, and one or more audio assets that may be used to replace the audio segment.

Finally, it should be understood that in various embodiments the audio track avail creation module 400 is also configured to read and edit audio track avails from existing audio track avail files. Thus, in various embodiments, the user may also upload existing audio track avails so that he or she can edit existing audio track avails and/or create new audio track avails for particular video assets.

### Replacement Module

In various embodiments, the replacement module 600 resides in a system that is configured to distribute video assets for viewing. For instance, in particular embodiments, the replacement module 600 resides in a service provider's system 200 as shown in FIG. 2. In these particular embodiments, the replacement module 600 replaces audio segments with audio assets in video assets the content provider intends to broadcast (and/or unicast) over its distribution network 207. Further, in particular embodiments, the replacement module 600 may work in conjunction with software and/or hardware components that select and stream the video assets. For example, the service provider system 200 shown in FIG. 2 includes a VOD server 201 and a headend 206. The VOD server 201 is configured to receive a request for a video asset, retrieve the video asset based on the request, and provided the video asset to be streamed over the service provider's distribution network 207. Thus, in various embodiments, the VOD server 201 provides the video asset to the replacement server 300 (on which the replacement module 600 resides) so that the identified audio segments in the video asset may be replaced with audio assets. In addition, the headend 206 is configured to stream the video asset over the provider's distribution network to various subscribers of the provider. Therefore, in various embodiments, the headend 206 receives the video asset from the replacement server 300 with the audio track with the replacement audio assets. As a result, the headend 206 streams the video asset over the provider's distribution network and subscribers who view the video asset will hear the audio assets in place of the audio segments.

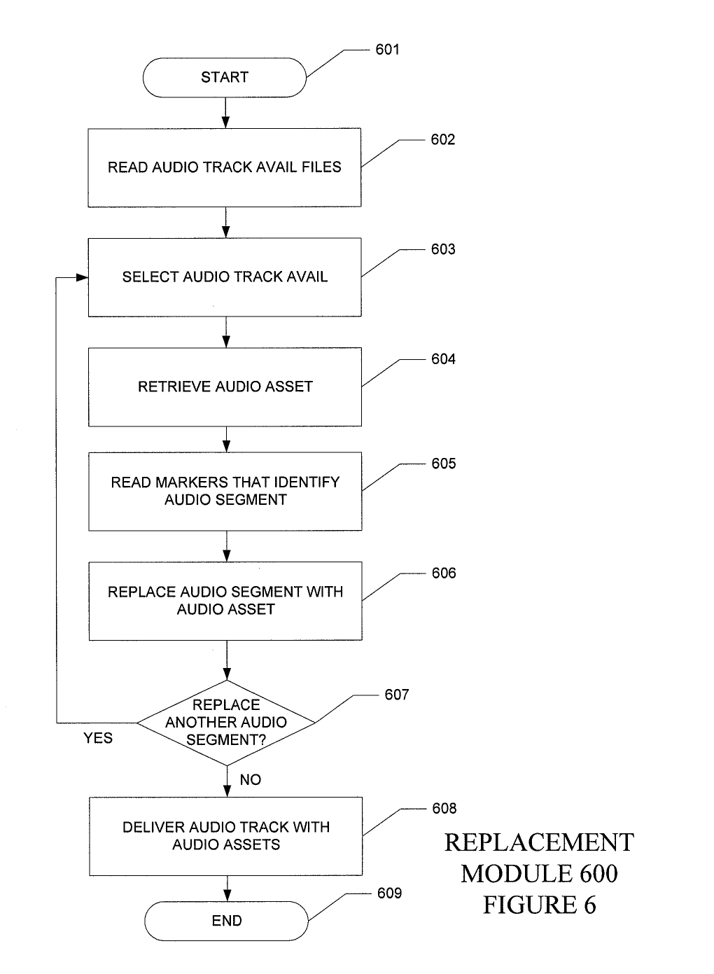

Accordingly, FIG. 6 illustrates a flow diagram of a replacement module 600 according to various embodiments. This flow diagram may correspond to the steps carried out, for instance, by the processor 60 in the server 300 depicted in FIG. 3 as it executes the module 600 in the server's RAM memory 67 according to various embodiments.

In various embodiments, a video asset (e.g., a motion picture or television program) and the asset's audio track avail files are provided to a content provider, such as a cable service provider. The provider schedules to broadcast the asset over its distribution network 207 and sets up its system 200 to accommodate. Thus, at the scheduled time, the provider's system 200 (e.g., VOD server 201) begins to deliver the asset to the replacement module 600 residing on the replacement server 300.

In particular embodiments, the system 200 may institute a lag time between the replacement module 600 processing the video asset and the system 200 delivering the asset to be streamed over the provider's distribution network 207. This lag time is built into the system 200 so that the replacement module 600 can process the video asset and replace one or more audio segments with audio assets (e.g., on-the-fly) before the asset is streamed over the distribution network 207. In other embodiments, the replacement module 600 may first replace all of the audio segments in the video asset and then deliver the asset to the headend 206 to be streamed over the provider's distribution network 207.

At Step 602, the replacement module 600 reads the audio track avail file(s) for the particular asset. For instance, in one embodiment, the replacement module 600 reads the file(s) from audio track avails storage 204 depicted in FIG. 2. As previously described, in various embodiments, the audio track avail files may include a listing of the audio track avails and an indication of the order in which the audio segments associated with the avails appear in the asset. For example, in one embodiment, the audio track avail files include a file that lists the audio track avails sequentially in the order in which the corresponding audio segments appear in the asset. In other embodiments, the replacement module 600 may read the available audio track avails from a listing in the video asset file.

At Step 603, the replacement module 600 selects an audio track avail from the available audio track avails for the video asset. Thus, in particular embodiments, the replacement module 600 selects the first available audio track avail found on the listing of audio track avails for the asset. In particular embodiments, the listing may also identify one or more files that are associated with the particular audio track avail. For instance, the listing may identify a file that contains all of the parameters for the audio segment associated with the particular audio track avail. Therefore, in this particular embodiment, the replacement module 600 reads the file that contains all of the parameters, retrieves the file (e.g., retrieves the file from the audio track avails storage 204), and accesses the parameters in the file.

As previously described, the parameters may comprise information on the audio segment associated with the audio track avail and/or on the audio track avail. In particular embodiments, the parameters may provide identifiers for one or more audio assets that may be used to replace the audio segment associated with the audio track avail in the video asset. For instance, returning to the example in which the user defined an audio track avail for the ring tone in the scene of the James Bond movie, the file may include several identifiers for audio assets that may be used to replace the audio segment in the movie that contains the ring tone (e.g., different audio asset for each wireless provider's ring tone). In this case, the service provider may have “auctioned” the rights to a wireless carrier to have the carrier's particular ring tone sound in the movie. Thus, the replacement module 600 may be provided with selection information to select the appropriate identifier from the several identifiers provided in the audio track avail file. In various embodiments, this information may be stored on some storage or server within the service provider's system 200 or may be stored external to the system 200 and accessed by the service provider's system 200. In other embodiments, the audio track avail file may simply contain one identifier for an audio asset. For instance, returning to the example in which the user defined an audio track avail for the opening song of the James Bond movie, the file may contain the identifier for the audio asset for Guns N' Roses'® version of “Live and Let Die.”

Therefore, in Step 604, the replacement module 600 retrieves the appropriate audio asset to be used to replace the audio segment associated with the audio track avail. For instance, in one embodiment, the replacement module 600 retrieves the audio asset using the identifier from the audio asset storage 203 shown in FIG. 2.

In Step 605, the replacement module 600 reads the markers from the audio track avail file (or from the video asset file) that identify the location of the audio segment in the audio track for the video asset. For example, the markers may include the starting time code (e.g., pointer) and the ending time code (e.g., indicator) in the video asset file for where the audio segment is located in the audio track. Further, in various embodiments, the replacement module 600 may also read the channels on which the audio segment is located. Thus, at Step 606, the replacement module 600 extracts the audio segment from the appropriate channels in the audio track based on the markers and replaces the audio segment with the audio asset.

In Step 607, the replacement module 600 determines whether to replace any additional audio segments in the video asset. For instance, in one embodiment, the replacement module 600 reads the listing of available audio track avails for the video asset and determines whether the module 600 has processed all of the audio track avails (e.g., determines whether end-of-file has been reached). If the replacement module 600 determines to replace another audio segment, the module 600 returns to Step 603 and selects another audio track avail. If the replacement module 600 determines not to replace another audio segment, the module 600 delivers the video asset file with the audio track with the inserted audio assets to the headend 206 so that the headend 206 can stream the video asset over the provider's distribution network 207.

As a result, the provider's system 200 then provides the video asset to the headend 206 to stream over the provider's distribution network 207 with the audio track with the inserted audio assets. As a result, a viewer watching the movie will hear the audio assets (instead of the audio segments) in the scenes of the movie in which the audio assets were inserted. For example, the viewer will hear Guns N' Roses'® version of “Live and Let Die” and the carrier's ring tone in the James Bond move when it is viewed.

It should be noted that in various embodiments the replacement module 600 may process each audio track avail for the video asset entirely before providing the video asset file to the provider's headend 206. While in other embodiments, the replacement module 600 may replace the audio segments on-the-fly while the provider's headend 206 is streaming the video asset over the distribution network 207. That is, in various embodiments, Steps 607 and 608 are interchangeable.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for replacing an audio segment in a video asset file comprising an audio track, the system comprising:
memory storing one or more audio assets comprising audio to replace one or more audio segments; and
a processor adapted to:
obtain an audio track avail, the audio track avail comprising one or more parameters identifying the audio segment, the audio segment comprising at least a portion of the audio track, and the one or more parameters comprising a starting pointer that points to the start of the audio segment in the audio track, an ending indicator that indicates the end of the audio segment in the audio track, and at least one identifier identifying an audio asset of the one or more audio assets to replace the audio segment;
obtain the audio asset from the one or more audio assets stored in the memory by using the identifier;
replace the audio segment in the audio track by locating the audio segment in the audio track using the starting pointer and the ending indicator; and
provide the video asset file comprising the audio track with the audio asset in place of the audio segment.

2. The system of claim 1 further comprising:
a distribution network; and
a headend adapted to:
receive the video asset file with the audio track with the audio asset; and
stream the video asset file over the distribution network as one or more data packets to one or more set-top boxes, wherein the one or more set-top boxes generates signals from the data packets for one or more televisions to display the video asset and to provide sound from the audio track such that the audio of the audio asset is heard in place of the portion of the audio track that comprises the audio segment.

3. The system of claim 1, wherein:
the one or more parameters comprise at least two identifiers, each identifier identifying a particular audio asset; and
the processor is further adapted to:
retrieve selection information, the information providing guidance used to select one of the at least two identifiers; and
select one of the at least two identifiers based at least in part on the selection information, the selected identifier identifying the audio asset to replace the audio segment in the audio track.

4. A method for replacing an audio segment in a video asset file comprising an audio track, the method comprising the steps of:
obtaining an audio track avail via a computer device, the audio track avail comprising one or more parameters identifying an audio segment, the audio segment comprising at least a portion of the audio track, and the one or more parameters comprising a starting pointer that points to the start of the audio segment in the audio track, an ending indicator that indicates the end of the audio segment in the audio track, and at least one identifier identifying an audio asset comprising audio to replace the audio segment;
obtaining the audio asset from memory by using the identifier;
replacing the audio segment in the audio track, via the computer device, by locating the audio segment in the audio track using the starting pointer and the ending indicator; and
providing the video asset file with the audio track with the audio asset in place of the audio segment.

5. The method of claim 4 further comprising the steps of:
receiving the video asset file with the audio track with the audio asset at a headend; and
streaming, via the headend, the video asset file over a distribution network as one or more data packets to one or more set-top boxes, wherein the one or more set-top boxes generates signals from the data packets for one or more televisions to display the video asset and to provide sound from the audio track such that the audio of the audio asset is heard in place of the portion of the audio track that comprises the audio segment.

6. The method of claim 4, wherein:
the one or more parameters comprise at least two identifiers, each identifier identifying a particular audio asset, and the method further comprises the steps of:
retrieving selection information via the computer device, the selection information providing guidance used to select one of the at least two identifiers; and
selecting one of the at least two identifiers, via the computer device, based at least in part on the selection information, the selected identifier identifying the audio asset to replace the audio segment in the audio track.

7. A system for providing an audio track avail for an audio segment comprising at least a portion of the audio track of a video asset file, the system comprising:
a processor adapted to:
receive a starting pointer that points to the start of the audio segment in the audio track, an ending indicator that indicates the end of the audio segment in the audio track, and at least one identifier identifying an audio asset comprising audio to replace the audio segment; and
create the audio track avail by saving the starting pointer, the ending indicator, and the at least one identifier in one or more files, wherein the one or more files are used to retrieve the audio asset by using the identifier, locate the audio segment within the audio track by using the starting pointer and the ending identifier, and replace the audio segment with the audio asset.

8. A method for providing an audio track avail for an audio segment comprising at least a portion of the audio track of a video asset file, the method comprising the steps of:
receiving, via a computer device, a starting pointer that points to the start of the audio segment in the audio track, an ending indicator that indicates the end of the audio segment in the audio track, and at least one identifier identifying an audio asset comprising audio to replace the audio segment; and
creating, via the computer device, the audio track avail by saving the starting pointer, the ending indicator, and the at least one identifier in one or more files, wherein the one or more files are used by a computer system to retrieve the audio asset by using the identifier, locate the audio segment within the audio track by using the starting pointer and the ending indicator, and replace the audio segment with the audio asset.
